(19) United States
(12) Patent Application Publication
(10) Pub. No.: US 2004/0226327 A1
(43) Pub. Date: Nov. 18, 2004

(54) Multi-stage burglar-proof lock core

(76) Inventor: Hsieh Che Chou, Chang Hua (TW)

Correspondence Address: Hsieh Che Chou, Box 8-24, 235 Chung-Ho, Taipei, TW

(21) Appl. No.: 10/439,113

(22) Filed: May 12, 2003

(51) Int. Cl. E05B 27/06

(52) U.S. Cl. 70/358; 70/493

(57) ABSTRACT

A multi-stage burglar-proof lock core comprises a lock head, a multi-stage lock core installed in the lock head, and a plurality of elastomers inserted into the multi-stage lock core. Two parallel inserting holes are radially formed in the lock head with an angle of 45 degrees to the slots in the lock core. The lock core is formed with at least two core units. Each core unit has a through hole along the axial center of the lock hole. Each core unit has a penetrating hole aligned to a respective slot. Each penetrating hole is communicable to the through hole. The lower pin can enter into the penetrating hole of the lock core; while the elastomers are embedded into the slots and the inserting holes. When rotating a selected one of the core units through 45 degrees, the t through hough holes of all core units are aligned to be as a continuous keyhole.

### FIELD OF THE INVENTION

The present invention relates to locks, and particularly to a multi-stage burglar-proof lock core which has a plurality of lock cores so as to stop an unspecific key or drill and thus has a preferred burglar-proof effect.

### BACKGROUND OF THE INVENTION

As shown in FIG. 1, a prior art burglar-proof lock core is illustrated. The prior art includes a lock head 5, a lock core 6 in the lock head 5, and a plurality of elastomers 3 in the lock core 6. The lock core 6 is integrally formed. A lock hole 61 is formed along the axial direction of the lock head 1. A plurality of slots 62 are axially arranged on the top of the lock core 6. Each of the slots 62 is communicable to the key hole 61.

The lock core is integrally formed. When a drill is inserted into the keyhole, although, the front pins can be destroyed, the lock core is still driven by the drill so that the whole lock will be destroyed and thus it is dangerous.

Since the lock core is integrally formed, it has a fixed specification. If other lock is used, then a new lock core is made and thus the cost is high.

### SUMMARY OF THE INVENTION

Accordingly, the primary object of the present invention is to provide a multi-stage burglar-proof lock core which comprises a lock head, a multi-stage lock core installed in the lock head, and a bank of elastomers which is inserted into the multi-stage lock core. Two parallel inserting holes are radially arranged with an angle of 45 degrees to the slots in the lock core. The lock core is formed with three core units. Each core unit has a through hole along the axial center of the lock hole. Each core unit has a penetrating hole at a position aligned to a respective slot. Each penetrating hole is communicable to the through hole. The lower pin can enter into the penetrating hole of the lock core; while the elastomers are embedded into the slots and the inserting holes. When rotating a core unit through 45 degrees, the through holes of all core units are aligned to be as a continuous keyhole.

The various objects and advantages of the present invention will be more readily understood from the following detailed description when read in conjunction with the appended drawing.

### BRIEF DESCRIPTION OF THE DRAWINGS

FIG. 1 is an exploded perspective view of the lock core of the prior art.

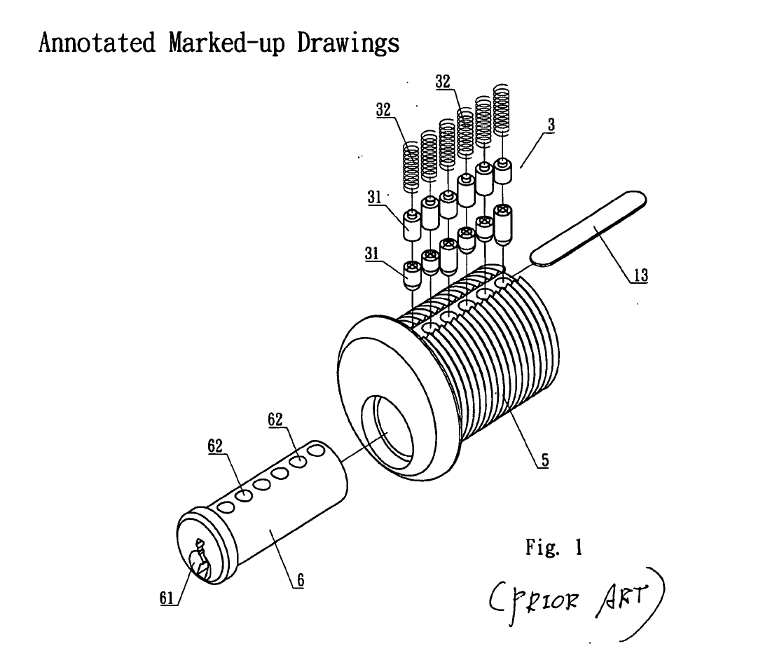

FIG. 2 is an exploded perspective view of the lock core of the present invention.

FIG. 3 is an assembled perspective view of the lock core of the present invention.

FIGS. 4A-4B show the operation of the multi-stage burglar-proof lock core of the present invention.

FIGS. 5A to 5D show another operation of the multi-stage burglar-proof lock core of the present invention.

### DETAILED DESCRIPTION OF THE PREFERRED EMBODIMENTS

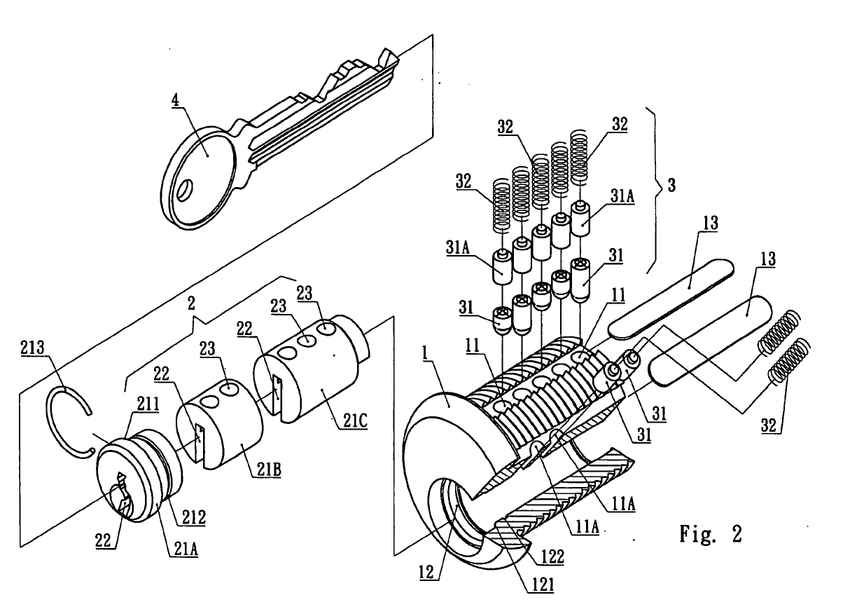

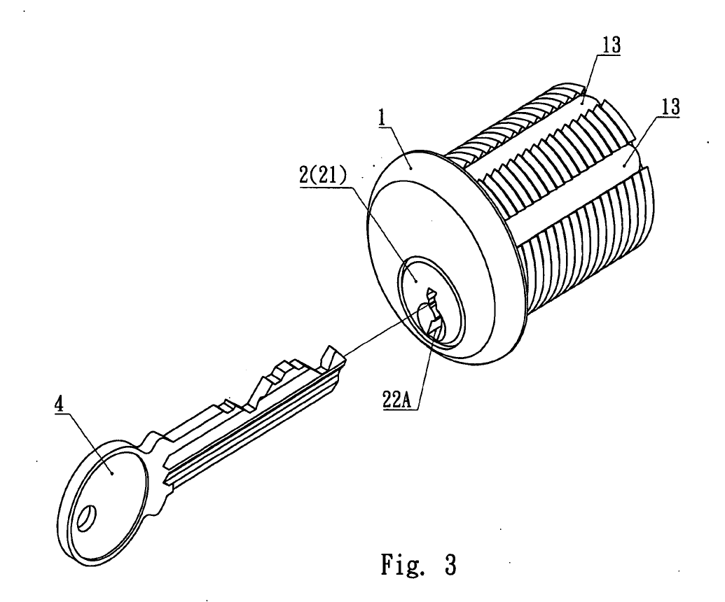

Referring to FIGS. 2 to 4, the embodiment of the present invention is illustrated. The present invention includes a lock head 1, a multi-stage lock core 2 installed in the lock head 1, and a plurality of elastomers 3 which is inserted into the multi-stage lock core 2.

A top of the lock head 1 has a bank of slots 11 along an axial direction of the lock head 1. Two parallel inserting holes 11A are radially formed in the lock head 1 with an angle of 45 degrees to the bank of the slots 11. The elastomer 3 can be inserted into the inserting holes 11A. A lock hole 12 is formed within the lock head 1 so that the lock core 2 can pass through the hole 12. A front end of the lock hole 12 has a stepped edge 121. An annular groove 122 is formed in an inner wall of the lock hole 12 and is more distant from the opening of the lock hole 12 than the stepped edge 121. A front core unit 21A can be engaged to the annular groove 122.

The lock core 2 is formed by a front core unit 21A at a front part, a middle core unit 21B at a middle part and a rear core unit 21C at a rear part so as to provide with a function of multi-stage burglar-proof.

An outer flange 211 is formed at a front end of the front core unit 21A. A surface of the front core unit 21A has an annular slot 212. A C ring 213 is buckled to the annular slot 212. The flange 211 of the front core unit 21A is exactly coupled to the stepped edge 121 of the lock hole 12. Thereby, the C ring buckled to the annular slot 212 can slide into the lock hole 12 from the stepped edge 121 and then is buckled to the annular groove 122.

The middle core unit 21B is formed by two base units, and the rear core unit 21C is formed by three base units. A through hole 22 passes through each of the central portion of the front core unit 21A, the middle core unit 211B and rear core unit 21C. Each base unit has a penetrating hole 23 at a position aligned to a respective slot 11. Each penetrating hole 23 is communicable to the through hole 22.

A key 4 can be inserted into each core units 21A, 21B and 21C. Then the key passes through the lock hole 12 so that core units can be fixed to a lock core 12 having a predetermined length. Thereby, the lock core 12 can be designed to match the lock head 1. After rotating through 45 degrees, the through holes 22 of the three core units are aligned to be as a continuous key hole 22A.

Each of the slot 11 and inserting hole 11A are inserted by a lower pin 31 and an upper pin 31A which are connected in series and then each elastomer 3 is placed upon the upper pin 31A. A cover 13 is placed upon the elastomer 3. The lower pin 31 can enter into the penetrating hole 23, while the elastomers 3 are embedded into the slots 11 and the inserting holes 11A. The lower pins 31 in the middle core unit 21B can be driven to be aligned to the inserting holes 11A so as to be formed as a two-stage lock core.

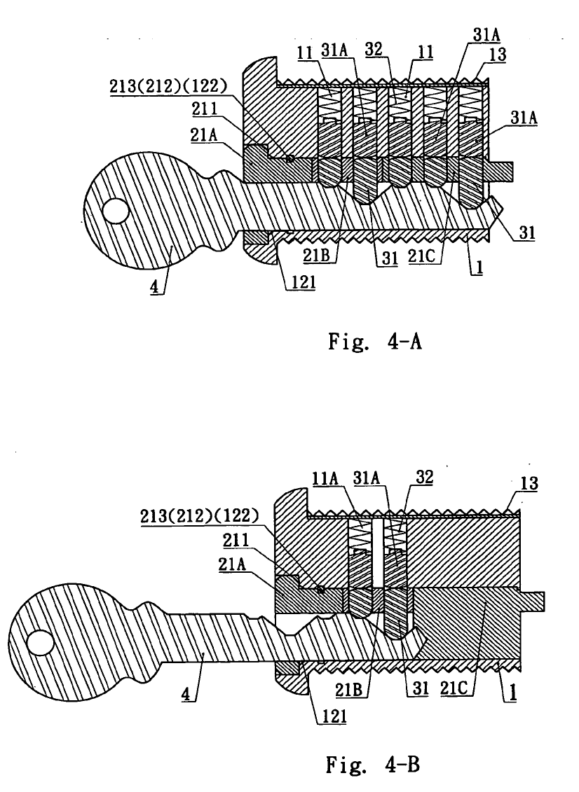

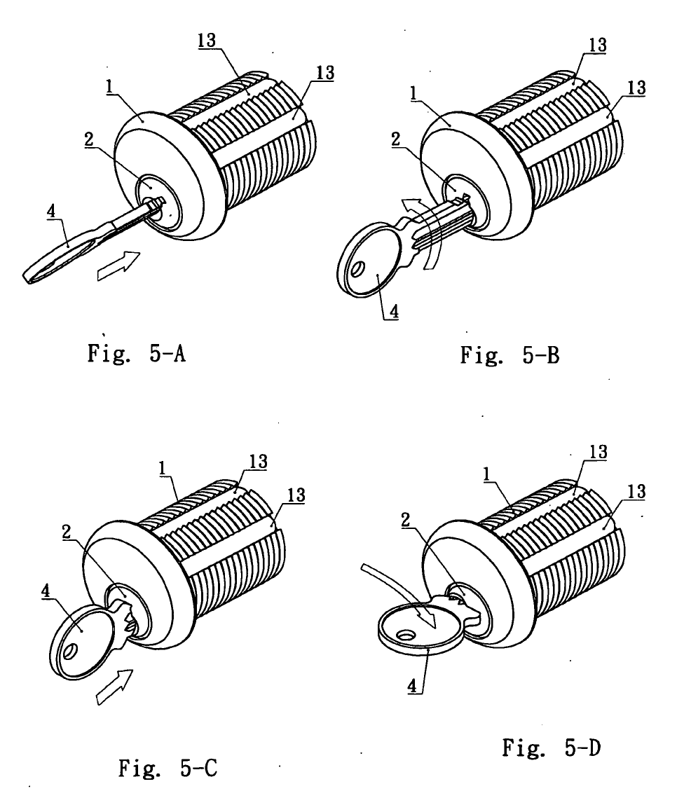

Referring to FIG. 5, the operation of the present invention will be described herein. Initially, the core unit 21B and the lower pins 31 thereof are aligned to the inserting holes 11A. When a key 4 inserts into the front core unit 21A, it is firstly stopped at a front surface of the core unit 21C, as shown in FIGS. 5A and 4B. Then the key 4 is rotated counterclockwise so as to drive the front core unit 21A, middle core unit 21B and lower pins 31 of the core unit 21B. As a result, the through holes 22 of the core unit 21B is aligned to the through holes 22 of the core unit 21C to from a continuous key hole 22, as shown in FIG. 5C. Finally, the whole lock core 2 is rotated clockwise through 90 degrees to be in lock state, as shown in FIG. 5D. Thus a two stage lock core 12 is formed.

Thereby, when a different key is inserted into the lock hole, it will be stopped in front of the middle core unit 21B due to mismatch of the keys. Since in the present invention, all the core units are independent, when a drill is inserted into the lock hole, the drill will rotate synchronously with the front core unit 21A so that the drill cannot further enter into the lock hole.

Moreover, the lock core 2 is formed with several units. The length of the lock core 2 is adjustable to match the size of the lock head 1.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1-4 (Cancelled)

5. A multi-stage burglar-proof lock core comprising
a lock head, a top of the lock head having a bank of at least three slots along an axial direction of the lock head; a lock hole penetrating into an interior of the lock head so that the lock core passing through the lock hole; a bank of two inserting holes being radially formed with an angle of 45 degrees to the bank of slots; each of the slots and inserting holes being inserted by a lower pin and an upper pin which are connected in series and then an elastomer is placed upon the upper pin; a cover being placed upon the elastomer; each inserting hole having a corresponding slot, which are located at the same circumference around a periphery of the lock head;
a lock core being formed by three core units, an integral formed front core unit, an integral formed middle core unit and an integral formed rear core unit; in assembly state, the middle core unit being aligned to all the inserting holes and the corresponding slots of the inserting holes; and the rear core being aligned to the other slot; each core unit having a through hole along the axial center of the lock hole; each core unit having a penetrating hole at a position aligned to a respective slot; each penetrating hole being communicable to the through hole; the lower pin can enter into the penetrating hole of the lock core; and the elastomers being embedded into the slots and the inserting holes;
wherein when rotating a selected one of the core units through 45 degrees, the through holes of all core units are aligned to be as a continuous key hole.

6. The multi-stage burglar-proof lock core as claimed in claim 5, wherein an outer flange is formed at a front end of the front core unit; a surface of the front core unit is formed with an annular slot; a C ring is buckled to the annular slot; the flange of the front core unit is exactly coupled to a stepped edge of the lock hole; thereby, the C ring buckled to the annular slot can slide into the lock hole from the stepped edge and then is buckled to the annular groove.

7. The multi-stage burglar-proof lock core as claimed in claim 5, wherein an outer flange is formed at a front end of the front core unit; a surface of the front core unit is formed with an annular slot; a C ring is buckled to the annular slot; the flange of the front core unit is exactly coupled to a stepped edge of the lock hole; thereby, the C ring buckled to the annular slot can slide into the lock hole from the stepped edge and then is buckled to the annular groove.
